(19) United States
(12) Patent Application Publication
(10) Pub. No.: US 2006/0155559 A1
(43) Pub. Date: Jul. 13, 2006

(54) System for examining title to a real estate parcel

(76) Inventor: Jerry L. Richardson, Johnson City, TN (US)

Correspondence Address: LUEDEKA, NEELY & GRAHAM, P.C., P O BOX 1871, KNOXVILLE, TN, 37901, US

(21) Appl. No.: 11/033,026

(22) Filed: Jan. 11, 2005

(51) Int. Cl. G06Q 99/00

(52) U.S. Cl. 705/1

(57) ABSTRACT

The above and other needs are met by a system for examining title to a real estate parcel including software operable on a processing device in electrical communication with a display for viewing information associated with the software. A database of electronic real estate documents is in electrical communication with the processing device and accessible using the software. A grantor list and grantee list of selectable links are viewable on the display device, such that the selectable links relate to electronic real estate documents.

### FIELD

The invention relates to systems for accessing property records. More specifically, the invention relates to a system and a method for making property records available on a network or computer system.

### BACKGROUND

Grantor and grantee indexes have been used for many years as a tool to trace title to specific parcels of land. Ordinarily, land titles are recorded in county courthouses, and are made available in large indexed volumes. These volumes, often referred to as grantor and grantee indexes, allow land titles to be traced back to a grant from an original owner of the property. The method of tracing title back is cumbersome and can entail significant labor expenses.

In a typical search for title, a person will look to the grantee index first (also referred to as the “indirect” index). The present owner will be found in the grantee index and the chain of title will be followed back in time to a certain point. Title may be traced back only fifty years in some jurisdictions, or perhaps back to the original owner of the property. When a desired point in a grantee index is reached, the searching party switches to a corresponding grantor index to trace title forward to the current owner. This process is used to ensure that no adverse interests have been created during the period being researched.

After a title search using grantor/grantee indexes has been completed, and if no encumbrances are found, the title is generally considered as valid for the given parcel of land. After completion of the title search, a certificate of title will often be provided to indicate a successful title search.

These searches, though conclusive, can be expensive and time consuming. The organization of these volumes can vary from county to county and from volume to volume. Often, an abstract is consulted in lieu of a traditional title search. Abstracts are essentially summaries of the pertinent information found in grantor/grantee indexes and other related documents. The benefit of using abstracts is that their use cuts down on the time required to gather and sift through relevant volumes of grantor/grantee indexes and other related documents. A distinctive drawback, however, is that abstracts are not the original documents found in grantor/grantee indexes and related volumes. It is generally accepted that the only failsafe way that good marketable title can be established is to trace title back to the original owner. Using the actual documents found in county courthouses best ensures the accuracy of such searches.

There is, therefore, a need for a system and an improved method that combines the use of actual grantor/grantee indexes and other related documents with a faster ways of accessing these actual indexes than sifting through them by hand.

### SUMMARY

The above and other needs are met by a system for examining title to a real estate parcel including software operable on a processing device in electrical communication with a display for viewing information associated with the software. A database of electronic real estate documents is in electrical communication with the processing device and accessible using the software. A grantor list and grantee list of selectable links are viewable on the display device, such that the selectable links relate to electronic real estate documents. The present invention is preferably operable on the internet.

The grantor list and grantee list preferably link to lists of grantor index links and lists of grantee index links respectively. The grantor index links direct a user to grantor indexes and the grantee index links direct a user to grantee indexes. The grantor list and grantee list may also link directly to grantor and grantee indexes. The present invention may also be used to access electronic real estate documents such as deeds and platt maps.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a screen shot from a display device according to a preferred embodiment of the invention.

FIG. 2 is a second screen shot from a display device according to a preferred embodiment of the invention.

FIG. 3 is a third screen shot from a display device according to a preferred embodiment of the invention.

### DETAILED DESCRIPTION

The invention provides a system and method for combining copies of actual grantor/grantee volumes and other related documents with a network for accessing these copies. In a preferred embodiment, the system includes software that is operable on a processing device. The processing device has access to a display device that is connected to the processing device. The connection between the display device and the processing device may be a wired or a wireless system.

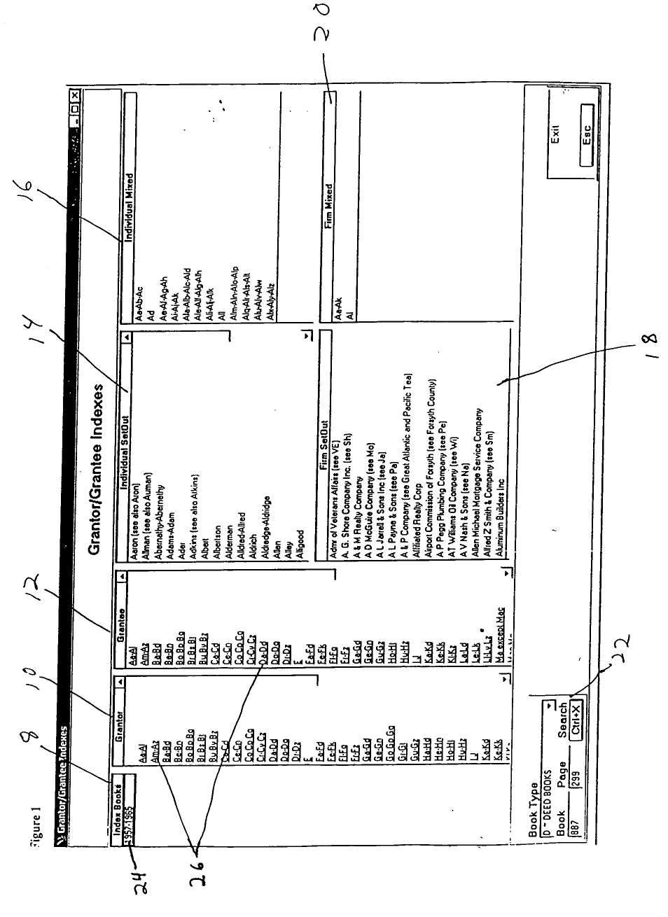

With reference now to FIG. 1, a screen shot from the display device is shown according to a preferred embodiment of the invention. In a preferred embodiment, a plurality of selectable links are displayed on the display device. Preferably, the selectable links are arranged in a plurality of lists.

In a preferred embodiment, an Index Book list 8 includes at least one selectable link 24. Each selectable link 24 represents at least one set of Grantor/Grantee indexes. In a preferred embodiment, the selectable links 24 of the Index Book list 8 are organized sequentially based on the date of corresponding books of Grantor/Grantee Indexes. When a selectable link 24 of the Index Book list 8 is chosen by a user, a corresponding Grantor list 10 and a Grantee list 12 are displayed.

In a preferred embodiment, the Grantor list 10 and the Grantee list 12 include a plurality of selectable links 26. The Grantor list 10 includes selectable links 26 related to grantors of real estate parcels. The Grantee list 12 also includes the selectable links 26 related to grantees of real estate parcels. Preferably, the selectable links 26 of the Grantor list 10 are alphabetically organized based on the first letter or letters of the grantors' respective surnames or business names. The selectable links 26 of the Grantee list 12 are alphabetically organized based on the first letter or letters of the grantees' respective surnames or business names. In an alternate embodiment, the Grantor list 10 and the Grantee list 12 may be organized using other applicable methods, such as organization by the address of the real estate parcel.

Preferably, each selectable link 26 of the Grantor list 10 corresponds to a collection of Grantor indexes and each selectable link of the Grantee list 12 corresponds to a collection of Grantee indexes. The collections of Grantor indexes and Grantee indexes are preferably book of indexes as kept in the Register of Deeds for the particular county being searched.

Preferably, each of the selectable links 26 in the Grantor list 10 correspond with at least one index list of selectable links. When a selectable link of the Grantor list 10 is chosen by a user, at least one corresponding index list is displayed. In a preferred embodiment, four index lists are displayed including an individual surname list 14 of selectable links, an individual mixed list 16 of selectable links, a firm name list of selectable links 18, and a firm mixed list 20 of selectable links. Each of the selectable links of the index lists corresponds with a particular Grantor index page or set of grantor index pages. When a selectable link of an index list is chosen by a user, the corresponding Grantor index pages are displayed on the display device.

The individual surname lists 14 preferably include selectable links including a surname. Each selectable link preferably corresponds to Grantor index pages. Every grantor listed on the index page preferably has the given surname. The individual mixed list 16 includes selectable links having an alphabetical range. Each selectable link preferably corresponds to grantor index pages, with every grantor listed on the index page preferably having a surname within the alphabetical range. The firm name list 18 includes selectable links including firm names. Each selectable link preferably corresponds to grantor index pages, with every grantor listed on the index page preferably having the firm name. The firm mixed list 20 includes selectable links including an alphabetical range. Each selectable link preferably corresponds to grantor index pages, with every grantor listed on the index page preferably having a firm name within the alphabetical range.

The Grantee list 12 preferably functions substantially the same as the Grantor list 10. The selectable links 26 in the Grantee list 12 correspond with at least one index list of selectable links. When a selectable link of the Grantee list 12 is chosen by a user, at least one corresponding index list is displayed. In a preferred embodiment, as with the Grantor list 10, four index lists are displayed when a Grantee list 12 selectable link is chosen including an individual surname list 14 of selectable links, an individual mixed list 16 of selectable links, a firm name list of selectable links 18, and a firm mixed list 20 of selectable links. Each of the selectable links of the index lists corresponds with a particular Grantee index page or set of pages. When a selectable link of an index list is chosen by a user, the corresponding Grantee index pages are displayed on the display device.

In the preferred embodiment described above, the individual surname lists 14 preferably include selectable links including a surname. Each selectable link preferably corresponds to Grantee index pages. Every grantee listed on the index page preferably has the given surname. The individual mixed list 16 includes selectable links having an alphabetical range. Each selectable link preferably corresponds to grantee index pages, with every grantee listed on the index page preferably having a surname within the alphabetical range. The firm name list 18 includes selectable links including firm names. Each selectable link preferably corresponds to grantee index pages, with every grantee listed on the index page preferably having the firm name. The firm mixed list 20 includes selectable links including an alphabetical range. Each selectable link preferably corresponds to grantee index pages, with every grantee listed on the index page preferably having a firm name within the alphabetical range.

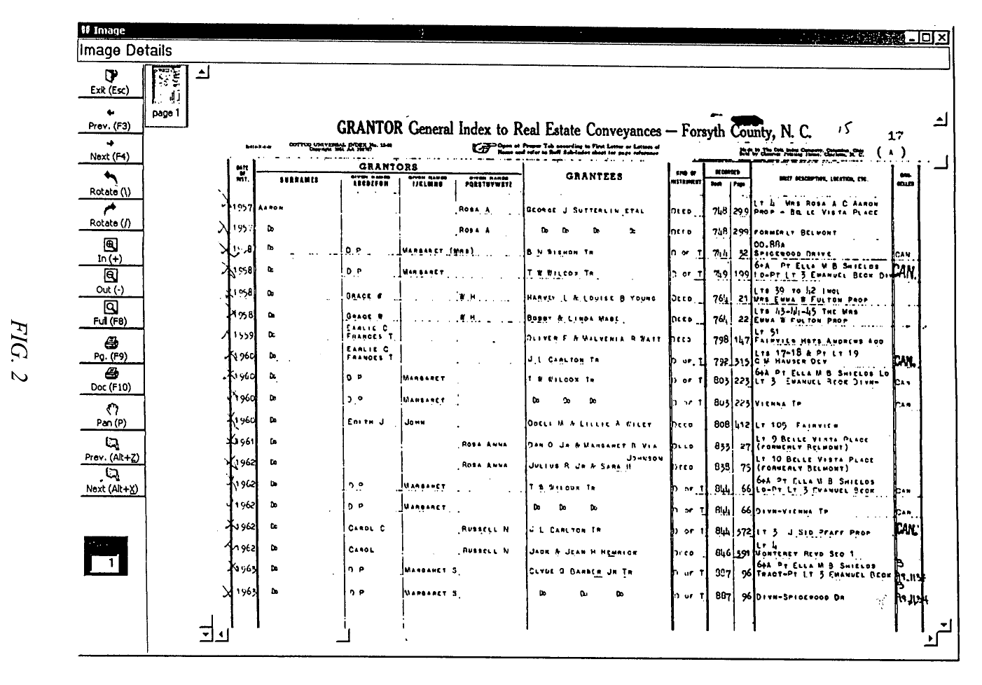

In a preferred embodiment, the displayed Grantee index pages and Grantor index pages may be electronically scanned documents. An example of a scanned Grantor index page is shown in FIG. 2. The Grantee and Grantor index pages are preferably scanned from the Grantor/Grantee index books located at Register of Deeds offices for the particular county being searched. The scanned documents are preferably located in an electronic database and are accessible using the software of the present invention. However, in alternative embodiments, the Grantor and Grantee index pages may be computer generated indexes. In one example, the computer generated indexes may be produced from a database of deeds.

As described above, once a user chooses a selectable link from an index list, a scanned grantor index or grantee index is displayed in a preferred embodiment of the invention. Preferably, as shown in FIG. 2, the indexes include a list of grantors and grantees corresponding to individual pieces of property. The indexes also include a record of the location in a deed book for each piece of property where the particular grant, or deed, of the property is recorded. Preferably, the location in the deed book is identified by a deed book number and page number.

In a preferred embodiment, the deeds may be displayed on the display device by entering the deed book number and page number into the deed book input device 22 as shown in FIG. 1. After the deed location is input into the deed book input device 22, the corresponding deed is then displayed on the display device. In alternate embodiments, the deeds may be displayed by the user by choosing a selectable link located on the index page. In another embodiment, the user may simply locate the actual deed book at the register of deeds for the searched county after finding the location using the present invention and find the particular deed desired.

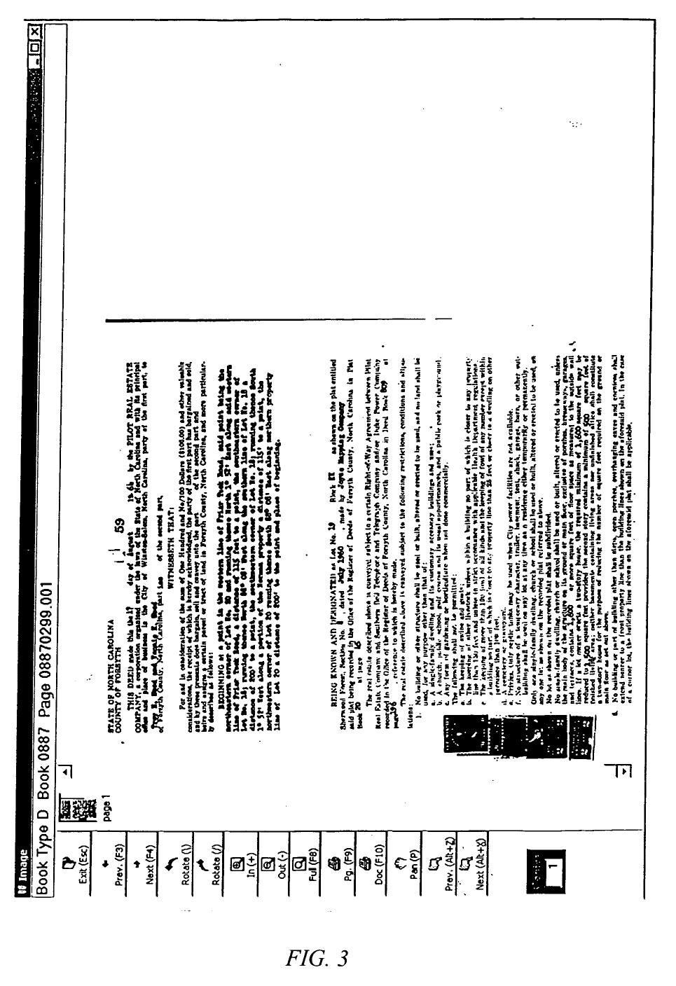

In a preferred embodiment, the deeds are electronically scanned documents. The deeds are preferably scanned from the deed books located at Register of Deeds offices for the particular county being searched. An example of a scanned deed is shown in FIG. 3. However, in alternative embodiments, the deeds may be computer generated informational pages produced from a database of deeds.

In alternate embodiments of the present invention, only one index list is displayed when a selectable link 26 from the Grantor list 10 or Grantee list 12 is chosen. For example, the surname selectable links, firm name selectable links, and mixed selectable links may all be listed in a single list in any organizational manner, such as alphabetically. In other embodiments, the index lists may be organized in any manner and have any number of lists that assists a user in locating particular Grantor index page or Grantee index page. In a further alternate embodiment, there are no index lists and the selectable links 26 of the Grantor list 10 may each correspond to a particular Grantor index and the selectable links 26 of the Grantee list 12 may each correspond to a particular Grantee index. In this further alternate embodiment, the particular Grantor and Grantee indexes are displayed when the corresponding selectable link 26 is chosen by a user.

In other alternate embodiments, the present invention may be used to obtain copies of other documents related to real estate parcels. For example, platt maps may be obtained for any real estate parcel or various documents related to the transfer of title of real estate parcels may be obtained.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. A system for examining title to a real estate parcel, the system comprising:
software operable on a processing device in electrical communication with a display for viewing of information associated with the software;
a database of stored electronic documents relating to real estate parcels in electrical communication with the processing device and accessible using the software; and
a plurality of selectable links viewable on the display device comprising a grantor list and a grantee list, the grantor list having selectable links related to grantors of real estate parcels and the grantee list having selectable links related to grantees of real estate parcels.

2. The system of claim 1, wherein at least one list of grantor index links is displayed when a selectable link from the grantor list is selected by a user.

3. The system of claim 2, wherein a grantor index from the database is displayed when a grantor index link is selected by a user.

4. The system of claim 1, wherein a grantor index from the database is displayed when a selectable link from the grantor list is selected by a user.

5. The system of claim 1, wherein at least one list of grantee index links is displayed when a selectable link from the grantee list is selected by a user.

6. The system of claim 5, wherein a grantee index from the database is displayed when a grantee index link is selected by a user.

7. The system of claim 1, wherein a grantee index from the database is displayed when a selectable link from the grantee list is selected by a user.

8. The system of claim 1, wherein the stored electronic documents comprise electronically scanned real estate documents.

9. The system of claim 8, wherein the scanned real estate documents comprise at least one of grantor indexes, grantee indexes, deeds, and platt maps.

10. The system of claim 1, wherein the system operates over the internet.

11. The system of claim 1, wherein the plurality of selectable links further comprises an index book list of selectable links, wherein each selectable link from the index book list corresponds to a particular grantor list and a particular grantee list, such that when a selectable link from the index book list is selected the particular grantor List and particular grantee List are displayed.

12. The system of claim 1, further comprising a deed book input device such that a deed may be displayed on the display device in response to information input into the deed book input device by a user.

13. A system for examining title to a real estate parcel, the system comprising software operable on a processing device having access to a display device and a plurality of selectable links displayed on the display device, wherein the plurality of selectable links comprises a first set of links related to grantor indexes and a second set of links related to grantee indexes.

14. The system of claim 13, wherein each link in the first set of links is selectable to display a first plurality of lists of links, wherein each of the links in the first plurality of list of links is selectable to display at least one grantor index.

15. The system of claim 14, wherein the first plurality of lists of links comprises an individual surname list of links to scanned individual surname grantor indexes wherein every grantor listed on the individual surname grantor indexes has substantially identical surnames, an individual mixed list of links to individual mixed grantor indexes wherein every grantor listed on the individual mixed grantor indexes has a surname within an alphabetical range, a firm name list of links to firm name grantor indexes wherein every grantor listed on the firm name grantor indexes has a substantially identical firm name, and a firm mixed list of links to firm mixed grantor indexes wherein every grantor listed on the firm mixed grantor indexes has a firm name within an alphabetical range.

16. The system of claim 13, wherein each link in the second set of links is selectable to display a second plurality of lists of links, wherein each of the links in the second plurality of list of links is selectable to display at least one grantee index.

17. The system of claim 16, wherein the first plurality of lists of links comprises an individual surname list of links to individual surname grantee indexes wherein every grantee listed on the individual surname grantee indexes has substantially identical surnames, an individual mixed list of links to individual mixed grantee indexes wherein every grantee listed on the individual mixed grantee indexes has a surname within an alphabetical range, a firm name list of links to firm name grantee indexes wherein every grantee listed on the firm name grantee indexes has a substantially identical firm name, and a firm mixed list of links to firm mixed grantee indexes wherein every grantee listed on the firm mixed grantee indexes has a firm name within an alphabetical range.

18. The system of claim 13, further comprising a deed book input device such that a deed may be displayed on the display device in response to information input into the deed book input device by a user.

19. The system of claim 13, wherein the grantor indexes comprise links selectable to display deeds granted by grantors listed on the grantor indexes and the grantee indexes comprise links selectable to display deeds received by grantees listed on the grantee indexes.

20. Software for examining title to a real estate parcel, the software comprising:
a database of stored electronic documents relating to real estate parcels; and
a plurality of selectable links for accessing the database, the plurality of selectable links comprising:
an index book list of links,
a grantor list of links,
a grantee list of links,
at least one grantor index list of links, and
at least one grantee index list of links.
